(19) United States
(12) Patent Application Publication
(10) Pub. No.: US 2023/0034400 A1
(43) Pub. Date: Feb. 2, 2023

(54) ELECTRICITY STORAGE MODULE AND BATTERY, CORRESPONDING MANUFACTURING PROCESS

(71) Applicant: Faurecia Systemes D'Echappement, Nanterre (FR)

(72) Inventors: Frédéric Greber, Ecot (FR); Nicolas Husy, Montbeliard (FR)

(21) Appl. No.: 17/871,974

(22) Filed: Jul. 24, 2022

(30) Foreign Application Priority Data
Jul. 27, 2021 (FR) 2108152

(51) Int. Cl. H01M 10/6556; H01M 50/211; H01M 10/6554; H01M 50/502

(52) U.S. Cl. CPC H01M 10/6556; H01M 10/6554; H01M 50/211; H01M 50/502

(57) ABSTRACT

The present disclosure relates to an electricity storage module and battery. It further relates to a corresponding manufacturing process for such a storage module and battery. The module comprises a plurality of electricity storage pouch cells each having a pouch and first and second electrodes protruding from the pouch, the pouch cells being juxtaposed along a principal direction and forming a stack embedded in a resin.

### PRIORITY CLAIM

This application claims priority to French Patent Application No. FR 21 08152, filed Jul. 27, 2021, which application is hereby incorporated in its entirety herein.

### BACKGROUND

The present disclosure relates in general to electricity storage batteries, in particular for motor vehicles.

Such batteries typically include one or more modules, each module itself including a plurality of electricity storage cells. These cells are electrically connected to each other.

When these cells are of the pouch type, the electrical connection of the cells to each other and the integration of the cells into the battery is carried out by means of complex shaped parts. The modules must be screwed to the battery envelope to give the battery a certain mechanical strength.

The resistance of the battery to impact can be problematic.

### SUMMARY

In this context, the present disclosure aims to provide a module for an electricity storage battery, comprising a plurality of pouch cells, which is easier to integrate into the battery.

To this end, the disclosure relates to a module for an electrical storage battery, the module comprising a plurality of electrical storage pouch cells each having a pouch and first and second electrodes protruding from the pouch, the pouch cells being juxtaposed along a principal direction and forming a stack embedded in a resin.

The module may further present one or more of the following features, considered individually or in any technically possible combination:
the first electrodes of the pouch cells extend in planes parallel to each other and are placed in a first line along the principal direction, two first electrodes adjacent in the first line being connected to each other by an electrical connector forming a block that is at least 60% solid;
the second electrodes of the pouch cells extend in planes parallel to each other and are placed in a second line along the principal direction, two adjacent second electrodes

in the second line being connected to each other by an electrical connector forming a block that is at least 60% solid;
each electrical connector comprises a substantially U-shaped folded electrically conductive sheet, electrically connecting the first or second adjacent electrodes to each other, the U-shaped folded sheet internally defining a volume filled with a plastic material;
each electrical connector comprises an internal duct for circulation of a heat transfer fluid;
the resin defines first and second faces opposite each other, external channels for the circulation of fluid being provided on the first and second faces, each internal duct fluidically connecting an external channel of the first face to an external channel of the second face;
in each pouch cell, the first and second electrodes are located on opposite sides of the pouch along a secondary direction, the external channels extending along the secondary direction;
thermally conductive plates are interposed in the stack between the pouch cells.
Electricity storage battery comprising at least

According to a second aspect, the present disclosure relates to an electricity storage battery comprising:
at least one module having the above characteristics;
an envelope internally delimiting a volume for receiving the at least one module; and
a circuit for cooling the pouch cells, comprising an inlet manifold distributing a heat transfer fluid into the external channels of the second face, and an outlet manifold collecting the heat transfer fluid leaving the external channels of the first face.

According to a third aspect, the present disclosure relates to a method of manufacturing a module for an electricity storage battery, the method comprising the following steps:
obtaining a plurality of electrical storage pouch cells each having a pouch and first and second electrodes protruding from the pocket;
juxtaposing the pouch cells along a principal direction, forming a stack;
overmolding a resin, the stack being embedded in the resin.

Other features and advantages of the disclosure will become apparent from the detailed description given below, by way of indication and not in any way limiting, with reference to the appended figures.

### BRIEF DESCRIPTIONS OF THE DRAWINGS

FIG. 1 is a perspective view of a battery conforming to the present disclosure, part of the cover not being shown to reveal the compartments receiving the modules;

FIG. 2 is a perspective view of the battery of FIG. 1, the cover not being shown and one of the modules being shown extracted from its compartment;

FIG. 3 is a perspective view, showing the different internal components of a module, separated from each other, and the resin embedding these components;

FIG. 4 is a perspective view of the internal components shown in FIG. 3, in the assembled state;

FIG. 5 is a perspective view of the module in FIGS. 1 to 4; and

FIG. 6 is an enlarged perspective view of a portion of the module in FIG. 5, with the resin covering the electrical connectors not shown to demonstrate the circulation of heat transfer fluid through the module.

### DETAILED DESCRIPTION

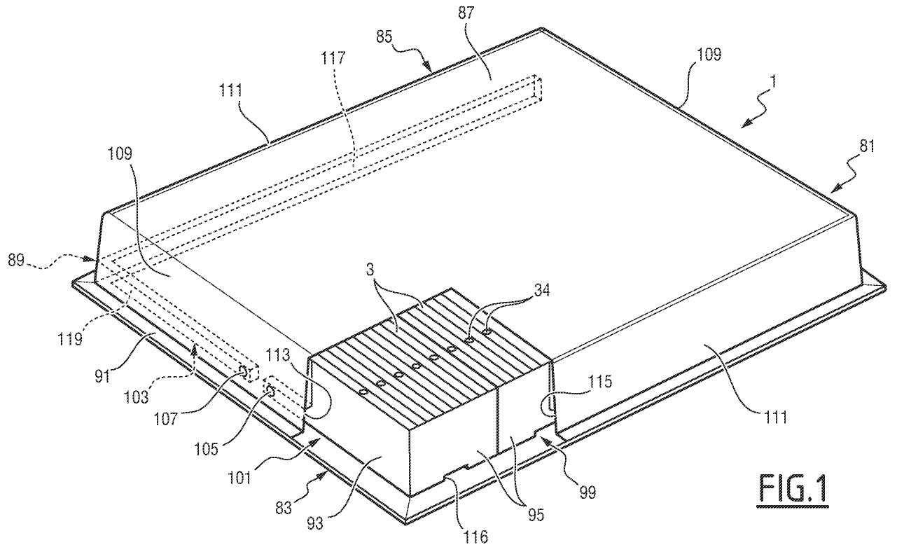

The battery 1 shown in FIG. 1 is an electricity storage battery. It is intended to equip a vehicle.

This vehicle is typically a motor vehicle, for example a car, a bus, a truck, etc...

The vehicle comprises, for example, an electric propulsion motor, electrically powered by the electricity storage battery 1. The vehicle is propelled exclusively by the electric motor.

Alternatively, the vehicle is of the hybrid type and thus includes an internal combustion engine and an electric motor powered electrically by the electric battery.

According to yet another variant, the vehicle is propelled by an internal combustion engine, the electric battery being provided to supply electrically other equipment of the vehicle, for example the starter, the lights, etc...

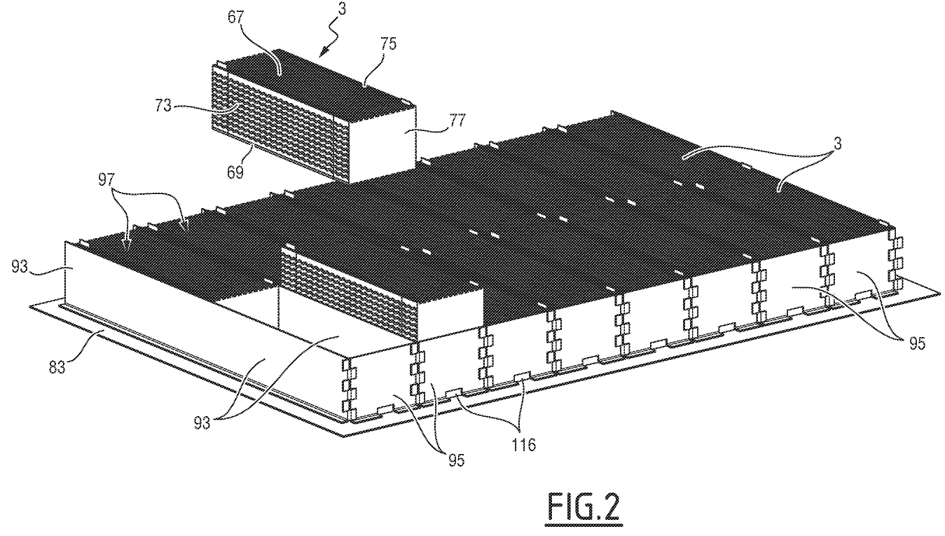

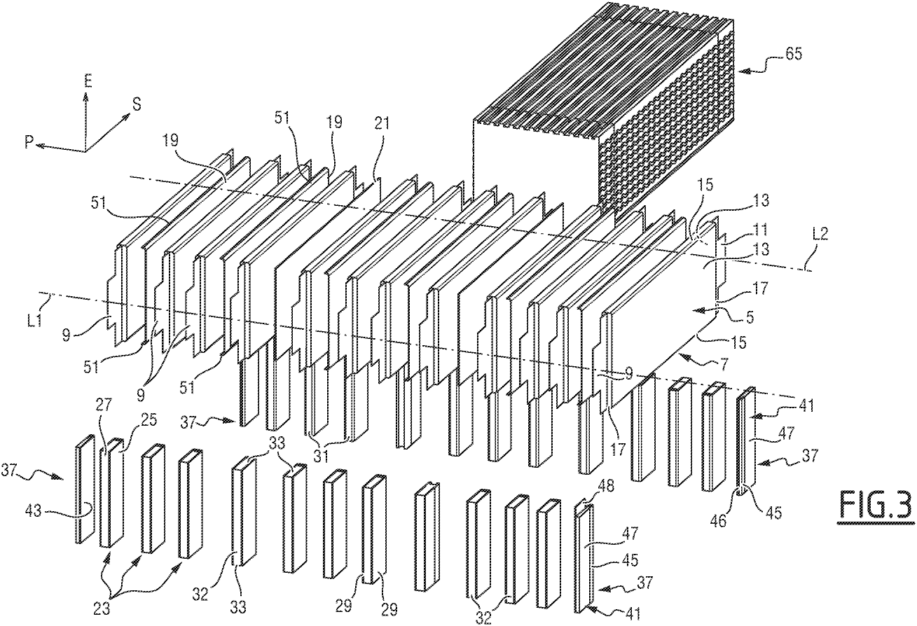

The electricity storage battery 1 comprises, as visible in FIGS. 1 and 2, at least one module 3, the module 3 itself comprising a plurality of electricity storage pouch cells 5 (FIG. 3).

Each pouch cell 5 includes a pouch 7 and first and second electrodes 9, 11 protruding from the pouch 7.

The pouch 7 is of any suitable type.

The pouch 7 typically includes a bag of flexible plastic material, an anode and a cathode housed within the bag, and an electrolyte filling the bag. The bag is sealed from the electrolyte.

The pouch 7 is thin, typically a few mm. Its thickness, taken along a principal direction P, is small compared to its length, taken along a secondary direction S, and its height, taken along an elevation direction E.

The principal direction P, the elevation direction E and the secondary direction S are perpendicular to each other. They are shown in FIG. 3.

In the example shown, the pouch 7 is rectangular, elongated along the secondary direction S.

The first and second electrodes 9, 11 are located on either side of the pouch 7 along the secondary direction S. The first and second electrodes 9, 11 are in electrical contact with the anode and cathode.

The first and second electrodes 9, 11 are flat metal parts, substantially inscribed in a median plane of the pouch 7.

The pouch cells 5 are juxtaposed along the principal direction P. They thus form a stack.

The principal direction P, in which the pouch cells 5 are stacked, is therefore substantially perpendicular to the planes in which the pouch cells 5 are located.

The pouch cells 5 are parallel to each other, in the sense that they are arranged in planes parallel to each other.

The pouch 7 presents two large faces 13 opposite each other. The large faces 13 are connected to each other by four edges, two edges 15 opposite each other and extending substantially according to the secondary direction S, and two edges 17 substantially opposite each other and extending substantially according to the elevation direction E. The first and second electrodes 9, 11 protrude from the pouch 7 through the edges 17.

Thermally conductive plates 19 are interposed in the stack between the pouch cells 5.

The plates 19 are typically made of aluminum or an aluminum alloy, such as 1000 series aluminum.

For example, the pouch cells 5 are grouped in pairs thermally, with a plate 19 being interposed between the pouch cells 5 in a same pair.

Thus, a plate 19 is interposed between the first and second pouch cells 5 in the stack, another between the third and fourth, yet another between the fifth and sixth, etc...

In some embodiments, sheets 21 of a compressible material are interposed in the stack, between the pouch cells 5.

The sheets 21 are, for example, of an open cell foam.

In the example shown, one sheet 21 is interposed every four pouch cells 5 in the stack.

The plate 19 extends in a plane perpendicular to the principal direction P. It presents substantially the same size as the pouch 7. It rests against the large faces 13 of the two pouch cells 5 between which it is inserted.

The sheet 21 also extends in a plane perpendicular to the principal direction P. It presents substantially the same size as the pouch 7. It is held against the large faces 13 of the two pouch cells 5 between which it is inserted.

The first electrodes 9 of the pouch cells 5 extend in planes parallel to each other. These planes are perpendicular to the principal direction P.

The first electrodes 9 are placed in a first line L1, along the principal direction P (FIG. 3).

The first electrodes 9 adjacent in the first line L1 are connected to each other by electrical connectors 23, visible in FIG. 3.

In exemplary embodiments, each electrical connector 23 forms a block that is at least 60% solid, and preferably at least 80% solid.

By this is meant that the empty areas inside the block represent between 0% and 40% of the total volume of this block, and preferably between 0% and 20%.

Thus, the first electrodes 9 are connected to each other by solid elements, which increases the mechanical coherence of the module 3.

Each electrical connector 23 comprises an electrically conductive sheet 25 folded into a U-shape, electrically connecting the first electrodes 9 which are adjacent to it, to each other. The U-folded sheet 25 internally delimits a volume filled with a plastic material 27.

The sheet 25 is, for example, an aluminum sheet. The sheet 25 is an elongated profile in the direction of elevation E. It presents U-shaped sections perpendicular to the direction of elevation 5. Its height in the direction of elevation E is substantially equal to that of the edge 17 of the pouch 7.

The U-shaped section 25 includes two lateral wings 29, and a core 31 connecting the two wings 29 to each other.

The wings 29 present, according to the secondary direction S, a width substantially equal to that of the electrodes 9. The core 31 has, according to the principal direction P, a width substantially equal to the spacing between the first two electrodes 9 that flank it.

The plastic material 27 is typically polypropylene (PP), polyethylene (PE), thermoplastic polyurethane (TPU), polyvinyl chloride (PVC).

Each electrical connector 23 is delimited by the two wings 29, as well as by the core 31.

Opposite the core 31, the electrical connector 23 is delimited by the surface 32 of the plastic material 27. This surface 32 is flat and fits substantially between the edges of the wings 29. It is substantially perpendicular to the secondary direction S.

The electrical connector 23, at its two opposite ends along the direction of elevation E, is still delimited by the surfaces 33 of the plastic material 27. The surfaces 33 also fit substantially between the edges of the wings 29. They are flat, and substantially perpendicular to the direction of elevation E.

Thus, each electrical connector 23 has a generally parallelepipedal shape.

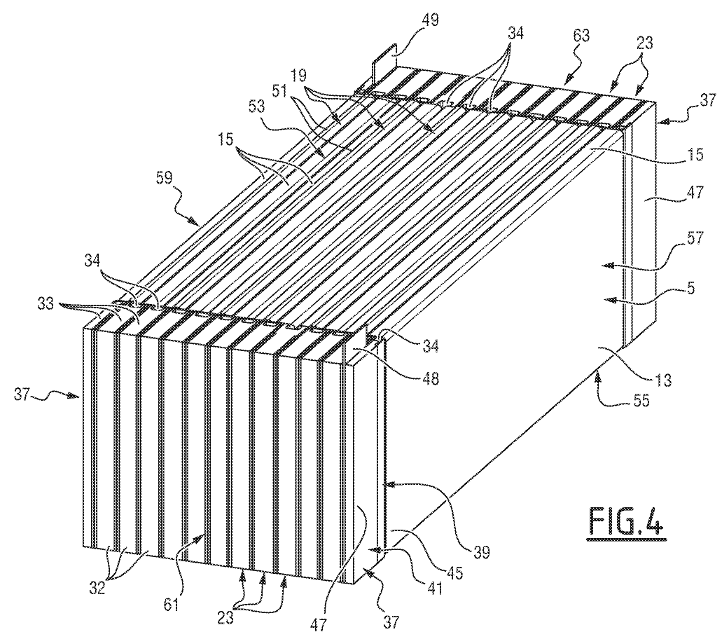

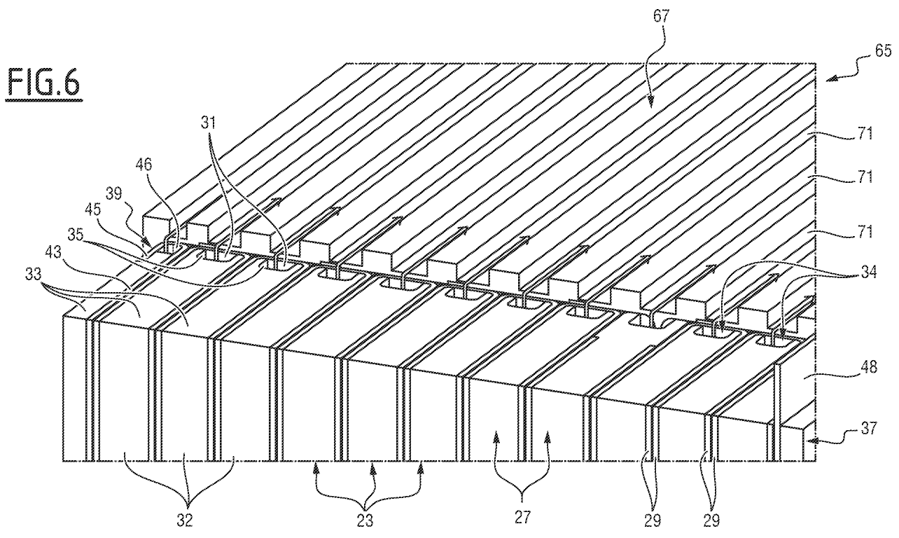

Each electrical connector 23 comprises an internal duct 34 for the circulation of a heat transfer fluid (see in particular FIGS. 4 and 6). The internal duct 34 extends over the entire height of the electrical connector 23, taken along the direction of elevation E. It is open at its two ends and opens out at the level of the two surfaces 33.

The internal duct 34 is delimited on one side by the core 31 of the electrically conductive sheet 25. It is also delimited by a groove 35 in the plastic material 27, as can be seen clearly in FIG. 6.

Thus, the heat transfer fluid circulating through the internal duct 34 is in direct contact with the core 31 of the sheet 25.

The second electrodes 11 of the pouch cells 5 are arranged like the first electrodes 9.

The second electrodes 11 extend in planes parallel to each other. These planes are perpendicular to the principal direction P.

The second electrodes 11 are placed in a second line L2, along the principal direction P (FIG. 3).

The second line L2 is parallel to the first line L1.

The adjacent second electrodes 11 in the second line L2 are connected to each other by an electrical connector 23 forming at least 60%, and preferably at least 80%, solid blocks.

The electrical connectors 23 of the second electrodes 11 are identical to those connecting the first electrodes 9 to each other.

The stacking of the pouch cells 5 is shown more precisely in FIG. 4. The large faces 13 of each pouch 7 are held against each other, either directly or with the interposition of a thermally conductive plate 19 or a sheet of compressible material 21.

In the assembled state, the electrical connectors 23 completely fill the space between the first electrodes 9, substantially without play.

The electrical connectors 23 completely fill the space separating the second electrodes 11, with no play.

As shown in FIGS. 3 and 4, the electrodes 9, 11 extend in the median plane of the pouch 7. In other words, the pouch 7 presents, on one side of said median plane a thickness e/2 and on the other side of the median plane a thickness e/2.

Here, e is the thickness of the pouch 7 taken along the principal direction P. The median plane is perpendicular to the principal direction P.

The electrical connectors 23 are engaged between the first electrodes 9.

The wings 29 are held against the first electrodes 9. The core 31 is held against the edges 17 of the pouch 7 of the two cells 5 between which the electrical connector 23 is placed.

The electrical connectors 23 present, along the principal direction P, a thickness substantially equal to e.

In the same way, the electrical connectors 23 are engaged between the second electrodes 11.

The wings 29 are held against the second electrodes 11 and the core 31 is held against the edges 17 of the pouches 7 of the cells 5 between which the electrical connector 23 is placed.

At both ends of the first line L1 are placed end connectors 37 having a thickness e/2.

These end connectors 37 each include an electrically conductive sheet 39 and a plastic material 41. The sheet 39 is folded into an asymmetrical U shape.

It comprises a first wing 43 held against the first electrode 9 located at the end of the first line L1. This first wing 43 presents the same size as the wings 29 of the electrical connectors 23.

The asymmetrical U-shaped sheet 39 presents a second wing 45 of narrower width than the first wing 43. The second wing 45 extends, according to the direction of elevation E, over the entire height of the end connector 37. Its width, taken along the secondary direction S, typically represents between 0% and 40%, and preferably between 0% and 20%, of the width of the first wing 43.

The first wing 43 and the second wing 45 are connected to each other by a core 46. The core 46 is held against the edge 17 of the pouch 7 located at the end of the stack.

The plastic material 41 of the end connectors 37 forms a layer covering the entire face of the first wing 43 turned towards the inside of the U. It presents the surfaces 32 and 33 that are an extension of the surfaces 32 and 33 of the electrical connectors 23. It presents a free surface 47 opposite the first wing 43, not covered by the second wing 45.

The end connector 37 includes an internal circulation duct 34 for the heat transfer fluid. This internal duct 34 extends to the bottom of the U-shaped portion of the sheet 39. More precisely, it is delimited by the core 46 of said sheet 39, and by the portions of the first and second wings 43, 45 attached to the core 46. It is closed by the plastic layer 41 of the end connectors 37.

End connectors 37 are also arranged at both ends of the second line L2.

These end connectors 37 are identical to those of the first line L1. They will not be described here in detail.

One of the two end connectors 37 of the first line L1 carries a tab 48 constituting one of the electrical poles of the module 3. This tab 48 is an extension of the first wing 43, and projects upwardly along the direction of elevation E relative to the connectors 23 and 37 of the first line L1.

Similarly, one of the end connectors 37 of the second line L2 carries a tab 49 constituting the second pole of the module 3. The tab 49 is formed by an extension of the first wing 43 and projects upwardly along the direction of elevation E relative to the connectors 23, 37 of the second line L2.

In the example shown, the tabs 48, 49 are located at opposite ends of the first and second lines L1, L2.

The thermally conductive plates 19 preferably present, at their opposite ends along the direction of elevation E, folded edges 51. The edges 51 are visible in FIG. 3. The folded edges 51 extend in planes perpendicular to the direction of elevation E. The folded edges 51 follow the top and bottom edges 15 of one of the pouches 7 according to the secondary direction S. They are held against the edges 15.

As shown in FIG. 4, the stack of pouch cells 5, the electrical connectors 23 and the end connectors 37 together form a compact block. This block is parallelepipedal in shape.

An upper surface 53 of this block is defined by the surfaces 33 of the electrical connectors 23 and the end connectors 37, by the edges 15 of the pouch cells 5 and the possible folded edges 51 of the plates 19. A lower surface 55 of this block is defined by the surfaces 33, as well as the edges 15 and possible folded edges 51 opposite.

A side surface 57 of this block is defined by the large face 13 of the pouch cell 5 located at the end of the stack, and by the large faces 47 of the end connectors 37 located at one end of the first and second lines L1, L2. Another side surface 59 is defined by the large face 13 of the pouch cell 5 located at the other end of the stack, and by the large faces 47 of the end connectors 37 located at the other end of the first and second lines L1, L2.

One end surface 61 of the block is defined by the surfaces 32 of the electrical connectors 23 and the end connectors 37 of the first row L1. Another end surface 63 of the block is defined by the surfaces 32 of the electrical connectors 23 and the end connectors 37 of the second line L2

The pouch cell stack 5 is embedded in a resin 65.

More specifically, the stack of pouch cells 5, as well as the electrical connectors 23, are entirely embedded in the resin 65.

The end connectors 37 are also entirely embedded in the resin 65, except for the tabs 48, 49.

In some embodiments, the resin 65 covers at least the top and bottom faces 53, 55 of the block described above.

Typically, it also covers the side faces 57, 59 and the end faces 61, 63 of this block.

Thus, each of the faces 53, 55, 57, 59, 61, 63 are completely covered by a layer of resin 65.

This layer is typically between 0.5 and 5 mm thick, preferably between 0.6 and 3 mm.

The resin is a plastic material, for example polyurethane (PU), polyvinyl chloride (PVC) or any other elastic and flexible plastic resin.

In some embodiments, the resin 65 comprises a thermal conductivity doping element, the thermal conductivity of the resin thereby being between 1 and 10 W/m.°K, preferably between 2 and 4 W/m.°K.

The resin 65, in the absence of doping elements, typically has a conductivity of 0.2 W/m.°K.

The doping element is for example alumina (Al₂O₃).

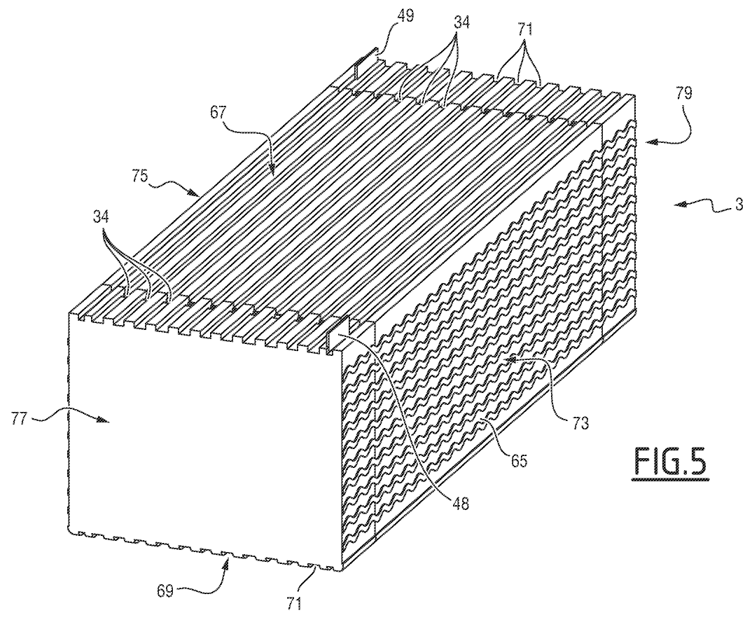

The resin 65 defines first and second faces 67, 69 opposite each other (FIGS. 5, 6). External fluid circulation channels 71 are provided on the first and second faces 67, 69 of the resin 65.

The first and second faces 67, 69 are defined by the resin layers covering the top and bottom faces 53, 55.

The external fluid circulation channels 71 are parallel to each other, straight, and extend along the entire length of the first and second faces 67, 69 of the resin 65. They extend according to the secondary direction S. The external fluid circulation channels 71 are open at both ends.

They are regularly spaced along the principal direction P, substantially over the entire width of the first and second faces 67, 69 of the resin 65.

The internal ducts 34 of the connectors 23, 37 located between the first electrodes 9 each fluidically connect an external fluid circulation channel 71 of the first face 67 to an external fluid circulation channel 71 of the second face 69.

In other words, these internal ducts 34, at their opposite ends, each open into an external fluid circulation channel 71 of the first face 67 and into an external fluid circulation channel 71 of the second face 69.

Similarly, the internal ducts 34 of the connectors 23, 37 connecting the second electrodes 11 together, each connect an external fluid circulation channel 71 of the first face 67 to an external fluid circulation channel 71 of the second face 69.

The resin 65 also defines the third and fourth faces 73, 75 opposite each other that are substantially flat. The third and fourth faces 73, 75 are delimited by the resin layers covering the surfaces 57, 59.

Similarly, the resin 65 defines the fifth and sixth faces 77, 79. The fifth and sixth faces 77, 79 are defined by the resin layers covering the end surfaces 61, 63.

The faces 67, 69, 73, 75, 77, 79 of the resin 65 define the outer surface of the module 3. This is generally parallelepipedal in shape.

As can be seen in FIG. 1, the electricity storage battery 1 includes, in addition to the modules 3, an envelope 81 delimiting internally a volume for receiving the modules 3.

The envelope 81 typically includes a baseplate 83 and a cover 85 (FIGS. 1 and 2).

In the example shown, the baseplate 83 is a substantially flat plate, constituting a frame supporting the weight of the modules 3.

The cover 85 has a concave shape towards the baseplate 83. It includes a substantially flat top face 87, a peripheral edge 89 surrounding the top face 87 and a projecting flange 91. The peripheral edge 89 extends from the top face 87 towards the baseplate 83. The flange 91 extends the peripheral edge 89. It is held against the baseplate 83.

For the example shown, the baseplate 83 of the envelope 81 is rectangular, with the top face 87 of the cover 85 also being rectangular.

The electricity storage battery 1 further includes beams 93, 95 attached to the baseplate 83 of the envelope 81. These beams 93, 95 define receiving housings 97 for the modules 3.

The beams 93, 95 are metal plates.

Each housing 97 is delimited by two transverse beams 93 and two longitudinal beams 95.

Each housing 97, in the example shown, is designed to receive two modules 3 placed in the extension of each other transversely.

The modules 3 are placed in the housing 97 with the second face 69 turned towards the baseplate 83 of the envelope 81 and the first face 67 turned towards the top face 87 of the cover 85.

The third and fourth faces 73, 75 of the resin 65 are turned towards the transverse beams 93.

One of the two modules 3 has its face 77 opposite one of the longitudinal beams 95, and its face 79 opposite the face 77 of the other module. This other module 3 has its face 79 opposite the other longitudinal beam 95.

The external fluid circulation channels 71 machined in the first faces 67 of the two modules 3 are positioned in the extension of the others.

In other words, each external fluid circulation channel 71 of the first module 3 is extended by a channel 71 of the other module 3 so that the heat transfer fluid can circulate continuously from one channel to the other.

Similarly, the external fluid circulation channels 71 of the second faces 69 of the two modules are placed in extension of each other. Thus, each external fluid circulation channel 71 of the first module 3 is placed in continuity with one of the external fluid circulation channels 71 of the second module 3, so that the heat transfer fluid circulates continuously from one channel to the other.

The electricity storage battery 1 further includes a cell cooling circuit 99.

The cooling circuit 99 comprises an inlet manifold 101, distributing the heat transfer fluid into the external fluid circulation channels 71 of the second faces 69 of the modules 3.

It also comprises an outlet manifold 103, collecting the heat transfer fluid leaving the external fluid circulation channels 71 of the first faces 67 of the modules 3.

Typically, the envelope 81 presents a heat transfer fluid inlet 105, through which the heat transfer fluid enters the cooling circuit 99. It also includes a heat transfer fluid outlet 107, through which the heat transfer fluid exits the cooling circuit 99.

The heat transfer fluid inlet 105 and the heat transfer fluid outlet 107 are designed to be connected to a cooling circuit on board the vehicle, typically comprising a heat transfer fluid circulation unit and a heat exchanger. The heat exchanger is designed to remove the heat generated by the pouch cells 5. The circulation unit sets the heat transfer fluid in motion. Its delivery pipe is fluidically connected to the heat transfer fluid inlet 105 and its return pipe to the heat transfer fluid outlet 107.

Alternatively, the heat exchanger and the circulation unit are integrated into the electricity storage battery. In this case, the outlet manifold is fluidically connected to an inlet of the heat exchanger, with the inlet manifold being fluidically connected to the delivery pipe of the circulation unit. The return pipe of the circulation unit is connected to the outlet of the heat exchanger.

The heat transfer fluid is typically a dielectric liquid, for example an oil. Alternatively, the heat transfer fluid is a gas.

In the illustrated example, the peripheral edge 89 of the cover 85 is rectangular and includes two transversely oriented sections 109 and two longitudinally oriented sections 111.

The longitudinal sections 111 extend parallel to and opposite the longitudinal beams 95.

The transverse beams 93 are arranged in a line, parallel to each other. The transverse sections 109 are arranged parallel to and opposite the transverse beams 93 located at both ends of the line.

The heat transfer fluid inlet and outlet 105, 107 are arranged in one of the transverse sections 109.

The inlet manifold 101 comprises a first part 113 of transverse orientation, arranged between the transverse section 109 carrying the heat transfer fluid inlet and outlet 105, 107 and the transverse beam 93 opposite. This first portion 113 extends from the heat transfer fluid inlet 105 to the end of the transverse beam 93.

The inlet manifold 101 further includes a second portion 115, extending the first portion 113, and extending longitudinally on one side of the electricity storage battery 1, between one of the longitudinal sections 111 and the longitudinal beam 95 opposite.

The longitudinal beams 95 present, in the lower portion, an opening 116 for the heat transfer fluid. The longitudinal beams 95 present as many openings 116 as there are external fluid circulation channels 71. This opening is located flush with the baseplate 83 of the envelope 81. Each opening 116 puts the inlet manifold 101 in communication with the external fluid circulation channels 71 located on the second face of the module 3 closest to the longitudinal beam 95.

The outlet manifold 103 includes a longitudinal portion 117 extending along one side of the electrical storage battery 1 opposite the second portion 115. The outlet manifold 103 further comprises a transverse orientation portion 119, fluidically connecting the longitudinal portion 117 to the heat transfer fluid outlet 107.

The longitudinal portion 117 extends between the longitudinal section 111 of the peripheral edge 89 of the cover 85 and the longitudinal beams 95 located opposite the second portion 115 of the inlet manifold 101. The transverse portion 119 extends between the transverse section 109 of the peripheral edge 89 carrying the heat transfer fluid inlet and outlet 105, 107, and the opposite transverse beam 93.

The circulation of the heat transfer fluid in the electrical storage battery 1 will now be described.

The heat transfer fluid enters the cooling circuit 99 through the heat transfer fluid inlet 105. It first follows the inlet manifold 101, and more specifically the first portion 113 of this manifold and then the second portion 115 of this inlet manifold 101. From the second portion 115 of the inlet manifold 101, it is distributed into the openings 116 provided at the base of the longitudinal beams 95. From each opening 116, it is distributed into the external circulation channels 71 provided in the second face of the module 3 closest to the longitudinal beam 95.

The heat transfer fluid follows the external circulation channels 71. A first part of the heat transfer fluid passes through the internal ducts 34 provided at the end of the module 3 closest to the opening 116. This first part of the heat transfer fluid follows the internal ducts 34 and opens into the external circulation channels 71 located on the first face of the module 3.

By passing through the internal ducts 34, arranged in the electrical connectors 23, the heat transfer fluid cools the electrodes located on either side of these electrical connectors 23, through each sheet 25. Because the sheet 25 rests on the edges 17 of the two pouches 7 opposite the electrical connector 23, the heat transfer fluid also cools the electrode and the cathode housed in the pouches 7.

As indicated above, only a first portion of the heat transfer fluid arriving through the opening 116 is diverted into the internal ducts 34 closest to the opening 116. The rest of the heat transfer fluid follows the external circulation channels 71 beyond the internal ducts 34. A second portion of this heat transfer fluid is directed into the internal ducts 34 of the first module 3 furthest from the opening 116. A third portion of the heat transfer fluid follows the external circulation channels 71 beyond this second set of internal ducts 34 and feeds the external circulation channels 71 of the second module 3, which are placed in the extension of the external circulation channels 71 of the first module 3. The heat transfer fluid is distributed in the internal ducts 34 of the second module 3.

The heat transfer fluid leaving the internal ducts 34 of the first and second modules 3 is collected in the external circulation channels 71 of the first faces 67 of the first module 3 and the second module 3. They follow these external circulation channels 71 to the outlet manifold 103. They successively travel through the longitudinal portion 117 of the outlet manifold 103 and then through the transverse portion 119 of the outlet manifold 103 to the heat transfer fluid outlet 107.

Some of the heat is conducted through the plates 19 to the upper and lower folded edges 51, and then through the thin resin layer interposed between the folded edge 51 and the bottom of the external circulation channel 71 to the heat transfer fluid.

The method for manufacturing a module for an electrical storage battery will now be described.

This method is particularly suitable for the manufacture of the module described above. Conversely, the module described above is specifically designed to be manufactured by the above method.

The manufacturing methodcomprises the following steps:
obtaining a plurality of electricity storage pouch cells 5, each having a pouch 7 and first and second electrodes 9, 11 protruding from the pouch 7;
juxtaposing the pouch cells 5 along a principal direction P, forming a stack;
overmolding of a resin 65, the stack being embedded in the resin 65.

The pouch cells 5 are as described above.

Their first and second electrodes 9, 11 are electrically connected by electrical connectors 23 as described above.

The stack of pouch cells 5 with the electrical connectors 23 constitutes a block as described above and illustrated in FIG. 4.

This block includes end connectors 37 of the type described above.

The resin 65 is of the type described above. It is arranged around the block shown in FIG. 4 as described above.

The overmolding step is typically realized by placing the stack of pouch cells 5, equipped with connectors 23 and 37, in a mold. A layer of resin 65 is injected into the mold, so as to cover this assembly, except for the plates 48, 49 constituting the poles of the module 3 and the ends of the internal ducts 34.

The module 3 described above presents multiple potential advantages.

Because the stack of pouch cells is embedded in a resin, the module has excellent mechanical coherence. It is also particularly easy to arrange in an electricity storage battery.

It also presents a high thermal coherence, with reasonable temperature gradients, typically of the order of 5° C.

This module can be easily installed and removed from the battery 1.

Because the resin contains a thermal conductivity dopant, heat exchange between the heat transfer fluid and the pouch cells is facilitated.

Because the electrical connectors connecting the first electrodes of the module to each other are solid blocks, the mechanical coherence of the module is reinforced. This is also true for the second electrodes.

The fact that each electrical connector is in the form of an electrically conductive sheet folded into a U-shape, the interior of which is filled with a plastic material, makes it possible to produce this electrical connector in a convenient manner. This is particularly economical.

The use of thermally conductive plates inserted into the stack of pouch cells allows excellent cooling of the pouch cells. These plates are in thermal contact with the external fluid circulation channels via the folded edges.

The fact that each block comprises an internal duct for the circulation of a heat transfer fluid allows efficient cooling of the electrodes and more generally of the pouch cells. These internal ducts are easy to make and due to the constitution of each block, with a U-shaped folded sheet and a plastic filling material.

The overmolded resin can be used to make external channels on two opposite sides of the module. This makes it possible to organize the circulation of the heat transfer fluid in a simple and convenient way.

The circulation of the heat transfer fluid in the external channels contributes to the cooling of the pouch cells, in addition to the circulation in the internal ducts.

1. A module for an electrical storage battery, the module including a plurality of electrical storage pouch cells each having a pouch and first and second electrodes protruding from the pouch, the pouch cells being juxtaposed along a principal direction and forming a stack embedded in a resin.

2. The module according to claim 1, wherein the first electrodes of the pouch cells extend in planes parallel to each other and are placed in a first line along the principal direction, two first electrodes adjacent in the first line being connected to each other by an electrical connector forming an at least 60% solid block.

3. The module according to claim 1, wherein the second electrodes of the pouch cells extend in planes parallel to each other and are placed in a second line along the principal direction, two adjacent second electrodes in the second line being connected to each other by an electrical connector forming an at least 60% solid block.

4. The module according to claim 2, wherein each electrical connector comprises an electrically conductive sheet folded into a substantially U shape electrically connecting adjacent first or second electrodes to each other, the U-shaped folded sheet internally delimiting a volume filled with a plastic material.

5. The module according to claim 2, wherein each electrical connector comprises an internal duct for circulation of a heat transfer fluid.

6. The module according to claim 5, wherein the resin defines first and second faces opposite each other, with external fluid circulation channels provided on the first and second faces, each internal duct fluidly connecting an external channel of the first face to an external channel of the second face.

7. The module according to claim 6, wherein, in each pouch cell, the first and second electrodes are located on opposite sides of the pouch along a secondary direction, the external channels extending along the secondary direction.

8. The module according to any one of the claims 1, wherein thermally conductive plates are interposed in the stack between the pouch cells.

9. An electricity storage battery comprising.
at least one module according to claim 6;
an envelope internally delimiting a volume for receiving the at least one module;
a circuit for cooling the pouch cells, comprising an inlet manifold distributing a heat transfer fluid into the external channels of the second face, and an outlet manifold collecting the heat transfer fluid leaving the external channels of the first face.

10. A method for manufacturing a module for an electricity storage battery, the method comprising the following steps:
obtaining a plurality of electricity storage pouch cells each having a pouch and first and second electrodes protruding from the pouch;
juxtaposing the pouch cells along a principal direction, forming a stack;
overmolding a resin, the stack being embedded in the resin.
